(19) United States
(12) Patent Application Publication
(10) Pub. No.: US 2009/0160533 A1
(43) Pub. Date: Jun. 25, 2009

(54) DC-DC VOLTAGE CONVERTER HAVING STABILIZED DIVIDED OUTPUT VOLTAGE

(76) Inventor: Joo Ae LEE, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/189,990

(22) Filed: Aug. 12, 2008

(30) Foreign Application Priority Data
Dec. 20, 2007 (KR) 10-2007-0134650

(51) Int. Cl. G05F 3/16

(52) U.S. Cl. 327/536

(57) ABSTRACT

A DC-DC voltage converter includes a current comparator converting a fixed reference voltage and an input voltage to a corresponding reference current and input current. The current comparator compares levels of the reference current and input current to output a control signal. A charge pump converts an output voltage to corresponding to a target voltage by performing a charge pumping operation in response to the control signal. An input voltage providing unit divides the output voltage to output the input voltage which is fed back into the current comparator, and as such is capable of reducing the area occupied by the DC-DC voltage converter in the semiconductor device and improving current consumption.

### CROSS-REFERENCE TO RELATED APPLICATIONS

The present application claims priority to Korean patent application number 10-2007-0134650 filed on Dec. 20, 2007, which is incorporated herein by reference in its entirety.

### BACKGROUND OF THE INVENTION

The present invention relates to a voltage converter, and more particularly to a direct current (DC) to DC voltage converter which can be integrated into a semiconductor chip.

In recent, the wide use of portable devices required better portability through miniaturization of all parts in the portable devices. A voltage converter is one such component part considered to occupy a larger-than-optimal volume in a portable device, for which therefore a miniaturization is sought.

Conventional DC-DC voltage converters include a pulse width modulator type that uses inductors and diodes and a charge pump type that uses switches and capacitors. The pulse width modulator type DC-DC converter is limited in that it must be mounted on a semiconductor chip, and therefore, the charge pump type DC-DC voltage converter is generally used in the semiconductor chip.

The conventional DC-DC voltage converter compares a reference voltage and an output voltage, thereby generating a control signal. The control signal controls a switch according to the comparing result that operates a capacitor, and thus pumping charges to generate a high voltage. That is, the conventional DC-DC voltage converter includes a voltage comparator comparing a reference voltage and an output voltage.

In the conventional DC-DC voltage converter, the voltage comparator is configured so as to compare the reference voltage, which is set to correspond to a target voltage, with the output voltage. Reference voltages having different levels should be set so as to correspond to different levels of the target voltage. Therefore, the conventional DC-DC voltage converter requires a separate circuit providing the reference voltages, and the area of the semiconductor chip must be increased accordingly.

Further, since the reference voltage and the output voltage are increased as the target voltage is increased, there is a problem in that the power consumption of the voltage comparator is also increased.

Furthermore, the conventional DC-DC voltage converter has another problem in that a drifting error is generated when the output voltage reaches the target voltage since the output voltage, which is compared with the reference voltage, is not stabilized.

### SUMMARY OF THE INVENTION

The present invention provides a DC-DC voltage converter comprising a current comparator generating a control signal by converting a reference voltage and an input voltage to currents and comparing the converted currents and setting an arbitrary target voltage by adjusting W/L ratios between transistors receiving the reference voltage and input voltage in the current comparator to save the area occupied by the DC-DC voltage converter.

The present invention also provides, a DC-DC voltage converter that divides and stabilizes an output voltage and provides it as an input voltage thereby improving current consumption by comparing currents corresponding to low voltages and a drifting error generated when the output voltage reached to a target voltage.

According to a first aspect of the present invention, there is provided a DC-DC voltage converter, which includes a current comparator that converts a fixed reference voltage and an input voltage to corresponding reference current and input current and compares levels of the reference current and input current to output a control signal. A charge pump converts an output voltage that corresponds to a target voltage by performing a charge pumping operation in response to the control signal. An input voltage providing unit divides the output voltage to output the input voltage which is fed back into the current comparator.

Preferably, the reference voltage is outputted from a band gap reference voltage generator.

Preferably, the current comparator includes a current converting unit converting the reference voltage and input voltage to the corresponding reference current and input current. A current comparing unit compares the levels of the reference voltage and input voltage. An outputting unit drives the output of the current comparing unit to output the control signal.

Preferably, the current converting unit includes a reference current generating transistor connected between a first node and a ground terminal and operates according to the reference voltage to generate the reference current. An input current generating transistor is connected between a second node and a ground terminal and operates according to the input voltage to generate the input current.

Preferably, the current converting unit sets the target voltage by adjusting ratios of width and length (W/L) between the reference current generating transistor and the input current generating transistor.

Preferably, the ratios of width and length (W/L) between the reference current generating transistor and the input current generating transistor are set so that the input current having the same level as the reference current is generated when the output voltage is identical to the target voltage.

Preferably, the current comparing unit includes first and second PMOS transistors respectively connected between the power voltage terminal and the first and second nodes and having gates commonly connected with the first node, supplies the power voltage to the first and second nodes by the voltage of the first node and outputs the result of comparing the reference current and the input current to the second node.

Preferably, the input voltage providing unit includes a voltage divider providing a divided voltage obtained by dividing the output voltage, and a stabilizing unit removing a jitter of the divided voltage to provide stabilized input voltage.

Preferably, the divided voltage is obtained by dividing the output voltage with a plurality of serially connected resistive transistors by a power down signal.

Preferably, the resistive transistors have the same size and the same resistance ratio.

Preferably, the stabilizing unit includes a low-pass filter.

According to the present invention, it is possible to improve a current consumption and a drifting error generated at a vicinity of a target voltage by providing a DC-DC voltage converter which divides an output voltage and compares an input voltage obtained by stabilizing the divided voltage with a reference voltage to generate a control signal.

Also, according to the present invention, it is possible to save the area occupied by the DC-DC voltage converter in the semiconductor device by using a fixed voltage outputted from a band gap reference voltage generator as the reference voltage, setting an arbitrary target voltage by adjusting W/L ratios between transistors respectively receiving the reference voltage and input voltage, and converting the received reference voltage and input voltage to currents and comparing the converted currents.

### BRIEF DESCRIPTION OF THE DRAWINGS

FIG. 1 is a block diagram showing a DC-DC voltage converter according to an embodiment of the present invention.

FIG. 2 is a detailed circuit diagram showing an example of the current comparator in FIG. 1.

FIG. 3 is a detailed circuit diagram showing an example of the voltage divider in FIG. 1.

FIGS. 4A and 4B are waveform diagrams comparing stabilities of a control signal by jitter generated in an input voltage at the vicinity of a target voltage.

### DESCRIPTION OF SPECIFIC EMBODIMENTS

Hereinafter, preferred embodiments of the present invention will be described in detail with reference to the accompanying drawings.

The present invention relates to a DC-DC voltage converter that outputs an arbitrary target voltage using a fixed voltage outputted from a reference voltage generator as a reference voltage.

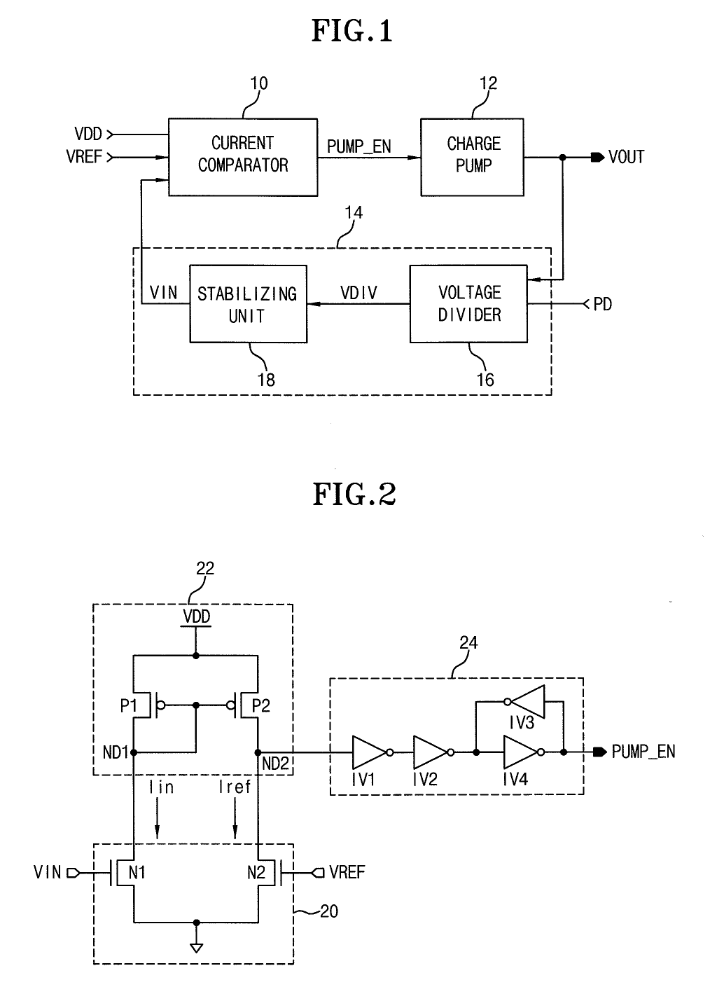

Referring to FIG. 1, the DC-DC voltage converter according to an embodiment of the present invention includes a current comparator 10, a charge pump 12, and an input voltage providing unit 14.

The current comparator 10 receives a reference voltage VREF and an input voltage VIN, converts the voltages to corresponding currents, compares the converted currents and outputs a control signal PUMP_EN according to the comparing result.

The charge pump 12 controls a switch in response to the control signal PUMP_EN to perform a charge pumping operation which pushes a charge to a capacitor or pulls the charge from the capacitor, thereby converting an output voltage VOUT. The charge pump 12 converts the output voltage to a target voltage VTOG according to the control signal PUMP_EN, and a structure thereof is well known in the art and thus is not described in detail.

The input voltage providing unit 14 divides and stabilizes the output voltage VOUT of the charge pump 12 and outputs the input voltage VIN which is fed back to the current comparator 10.

The current comparator 10 of the DC-DC voltage converter of the present invention will be described with reference to FIG. 2. The current comparator 10 includes a current converting unit 20 which converts the reference voltage VREF to a reference current Iref and converts the input voltage VIN to an input current Iin. The current comparator 10 further includes a current comparing unit 22 that compares the reference current Iref and the input current Iin The current comparator 10 also includes an outputting unit 24 that receives the output of the current comparing unit 22 at node ND2 and outputs a control signal PUMP_EN.

The current converting unit 20 includes NMOS transistors N1 and N2 respectively connected between nodes ND1 and ND2 and a ground terminal VSS. When the input voltage VIN is applied to the gate of the NMOS transistors N1, the input current Iin, corresponding to the input voltage VIN, flows to the NMOS transistors N1. Similarly, when the reference voltage VREF is applied to the gate of the NMOS transistors N2, the reference current Iref, corresponding to the input voltage VREF, flows to the NMOS transistors N2.

Here for example, the reference voltage VREF is a fixed voltage outputted from a band gap reference voltage generator (not shown). Therefore, the reference current Iref can be adjusted according to a ratio of the channel length L of the NMOS transistor N2 with respect to the channel width W of the NMOS transistor N2, i.e., the W/L ratio as shown in mathematical equation 1 below.

Iref=β(W/L)ref(VREF−Vt2)2 [Mathematical equation 1]

In the mathematical equation 1, the W/L ratio of the NMOS transistor N2 is “β(W/L)ref” and “Vt2” is the threshold voltage of the NMOS transistor N2.

Further, the input current Iin can be adjusted according to a W/L ratio of the NMOS transistor N1 as shown in mathematical equation 2 below.

Iin=(W/L)in(VIN−Vt1)2 [Mathematical equation 2]

In the mathematical equation 2, the W/L ratio of the NMOS transistor N1 is “β(W/L)in” and “Vt1” is the threshold voltage of the NMOS transistor N1.

The input voltage providing unit 14 (described in detail below) divides the output voltage VOUT to generate the input voltage VIN, which is given by the following mathematical equation 3 below.

VIN=αVOUT [Mathematical equation 3]

Meanwhile, the target voltage VTOG of the DC-DC voltage converter of the present invention as shown in FIG. 1, can be set by adjusting the W/L ratios between the NMOS transistors N1 and N2 so that the input current Iin and the reference current Iref are equal when the output voltage VOUT is equal to the target voltage VTOG. The ratios between NMOS transistors N1 and N2 for setting the target voltage VTOG that can be given by the following mathematical equation 4 below.

(W/L)in=(W/L)ref((VREF−Vt2)/(αVTOG−Vt1))2 [Mathematical equation 4]

As described above, it is possible to use a fixed reference voltage VREF since the target voltage VTOG can be set by adjusting the W/L ratios between the NMOS transistors N1 and N2. Therefore, the present invention is advantageous in that a separate circuit providing the VREF required in a conventional DC-DC voltage converter is not needed in the DC-DC voltage converter of the present invention and thus the area occupied by the DC-DC voltage converter can be reduced.

The current comparing unit 22 includes PMOS transistors P1 connected between a power voltage terminal VDD and the node ND1 and PMOS transistors P2 connected between a power voltage terminal VDD and the node ND2. The gates of PMOS transistors P1 and P2 are supplied with a voltage from node ND1, t and supply the power voltage VDD to the nodes ND1 and ND2, respectively. The current converting unit 20 compares the flowing input current Iin and the reference current Iref and outputs the result to the node ND2.

For example, if the input current Iin is greater than the reference current Iref, i.e., if the output voltage VOUT is greater than the target voltage VTOG, the output of the node ND2 is a logic high. On the contrary, if the input current Iin is less than the reference current Iref, i.e., if the output voltage VOUT is less than the target voltage VTOG, the output of the node ND2 is a logic low.

The outputting unit 24 includes inverters IV1 through IV4 and outputs the control signal PUMP_EN by driving and latching the output of the node ND2. In other words, the outputting unit 24 outputs the control signal PUMP_EN at the logic low when the output of the node ND2 is the logic high and outputs the control signal PUMP_EN at the logic high when the output of the node ND2 is the logic low.

Referring again to FIG. 1, the input voltage providing unit 14 includes a voltage divider 16 which divides the output voltage VOUT of the charge pump 12 and outputs a divided voltage VDIV, and a stabilizing unit 18 which removes the jitter component of the divided voltage VDIV and outputs stabilized input voltage VIN.

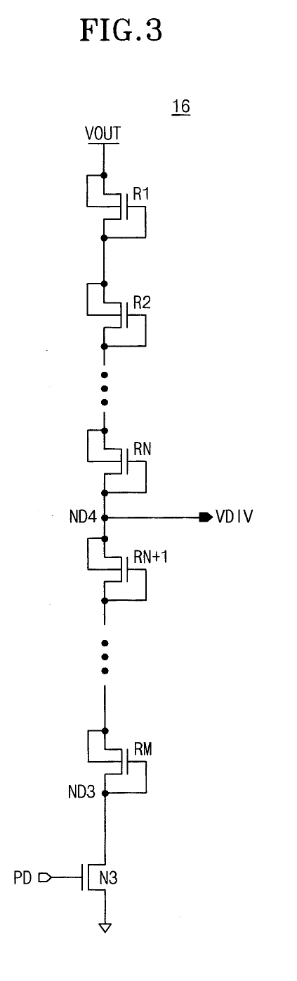

The voltage divider 16 of the DC-DC voltage converter of the present invention, as shown in FIG. 1, will be described with reference to FIG. 3. The voltage divider 16 includes a plurality of resistive transistors R1 through RM, (M is a natural number) serially connected between the output voltage VOUT and the node ND3 and an NMOS transistor N3 connected between the node ND3 and the ground terminal VSS.

The resistive transistors R1 through RM have a uniform size and a uniform resistance ratio reduce the output voltage VOUT according to the resistance ratio. The NMOS transistor N3 forms a current path between the output voltage VOUT and ground terminal VSS according to a power down signal PD applied to the gate of the NMOS transistor N3, thereby outputting the divided voltage VDIV. For example, the divided voltage VDIV outputted from a node ND4, located between Nth and (N+1)th transistors as shown in FIG. 3, is obtained by subtracting the product of N multiplied by the resistance ratio of the resistive transistor (i.e., N*the resistance ratio of the resistive transformer) from the output voltage VOUT. Herein, N is a natural number.

As such, according to an embodiment of the present invention, it is possible to reduce the size of a device and the current consumption of a device since it is possible to reduce the input current Iin and the reference current Iref by providing the divided voltage VDIV (which is lowered by dividing the output voltage VOUT) as the input voltage VIN.

The stabilizing unit 18 may include a low-pass filter, etc. to remove the jitter component generated in the input voltage VIN fed back when the output voltage VOUT passes through the target voltage VTOG. The low-pass filter is well known in the art and thus will not be described herein.

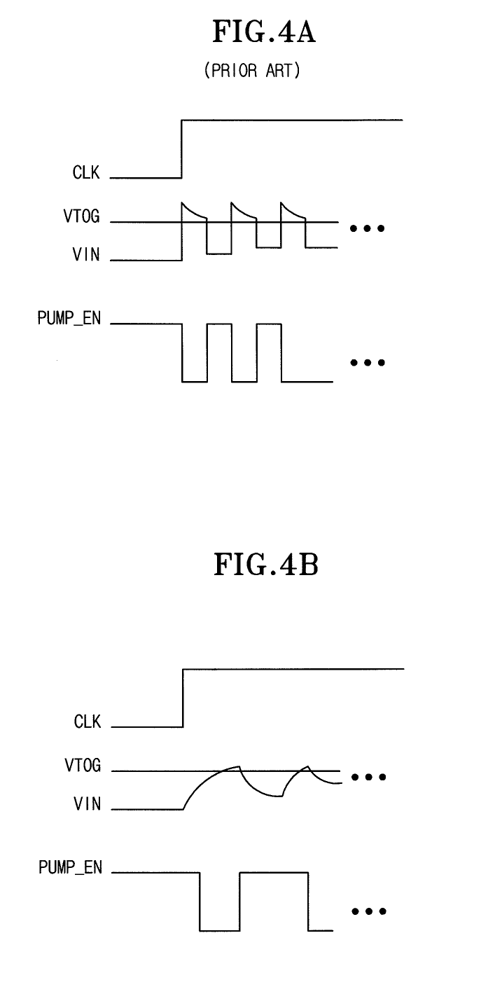

Referring to FIG. 4A, it can be appreciated that in the conventional device the outputted control signal PUMP_EN is not stabilized when the jitter component is generated in the input voltage VIN at the vicinity of the target voltage VTOG. As shown in FIG. 4B, the DC-DC voltage converter of the present invention outputs a stable control signal PUMP_EN since the stabilizing unit 18 is provided to remove the jitter component of the input voltage VIN at the vicinity of the target voltage VTOG. As the result, a ripple of the output voltage VOUT associated with the jitter component of the input voltage VIN is reduced.

Those skilled in the art will appreciate that the specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

What is claimed is:

1. A direct current (DC) to DC voltage converter, comprising:
a current comparator outputting a control signal by converting a fixed reference voltage and an input voltage to a corresponding reference current and input current and comparing levels of the reference current and the input current;
a charge pump converting an output voltage corresponding to a target voltage by performing a charge pumping operation in response to the control signal; and
an input voltage providing unit dividing the output voltage to output the input voltage, wherein the input voltage is supplied to the current comparator.

2. The DC-DC voltage converter as set forth in claim 1, wherein the reference voltage is outputted from a band gap reference voltage generator.

3. The DC-DC voltage converter as set forth in claim 1, wherein the current comparator comprises:
a current converting unit converting the reference voltage and input voltage to the corresponding reference current and input current;
a current comparing unit comparing the levels of the reference voltage and input voltage; and
an outputting unit outputting the control signal by driving the output of the current comparing unit.

4. The DC-DC voltage converter as set forth in claim 3, wherein the current converting unit comprises:
a reference current generating transistor connected between a first node and a ground terminal and generating the reference current according to the reference voltage; and
an input current generating transistor connected between a second node and a ground terminal and generating the input current according to the input voltage.

5. The DC-DC voltage converter as set forth in claim 4, wherein the current converting unit sets the target voltage by adjusting the width and length ratio (W/L ratio) of the reference current generating transistor and the W/L ratio of the input current generating transistor.

6. The DC-DC voltage converter as set forth in claim 5, wherein the W/L ratio of the reference current generating transistor and W/L ratio of the input current generating transistor are set so that the input current having the same level as the reference current is generated when the output voltage is equal to the target voltage.

7. The DC-DC voltage converter as set forth in claim 4, wherein the current comparing unit comprises:
a first PMOS transistor connected between the power voltage terminal and a first node; and
a second PMOS transistor connected between the power voltage terminal and a second node, the first and second PMOS transistors having gates commonly connected with the first node, and
wherein the current comparing unit supplies a power voltage from the power voltage terminal to the first and second nodes according to a voltage of the first node and outputs the result of comparing the reference current and the input current to the second node.

8. The DC-DC voltage converter as set forth in claim 1, wherein the input voltage providing unit comprises:
a voltage divider dividing the output voltage and outputting a divided voltage; and
a stabilizing unit removing a jitter component of the divided voltage and stabilizing the input voltage.

9. The DC-DC voltage converter as set forth in claim 8, wherein the divided voltage is obtained by dividing the output voltage with a plurality of serially connected resistive transistors according to a power down signal.

10. The DC-DC voltage converter as set forth in claim 9, wherein each of the plurality of resistive transistors have the same size and the same resistance ratio.

11. The DC-DC voltage converter as set forth in claim 8, wherein the stabilizing unit includes a low-pass filter.
